(19) United States
(12) Patent Application Publication
(10) Pub. No.: US 2004/0037989 A1
(43) Pub. Date: Feb. 26, 2004

(54) Photo and album system

(75) Inventors: Loretta E. Allen, Hilton, NY (US); Robert P. Bourdelais, Pittsford, NY (US); Mridula Nair, Penfield, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/225,609

(22) Filed: Aug. 22, 2002

(51) Int. Cl. B32B 9/00

(52) U.S. Cl. 428/40.1

(57) ABSTRACT

A kit for repositioning an image product on a mounting support. The kit comprises an image product having a back surface, with an adhesive layer, and a mounting support having a mounting surface for mating with the back surface of the image product so as to secure the image product to the mounting support. The adhesive layer enables both repeated positioning and also permanent mounting of the image product to the mounting surface.

### FIELD OF THE INVENTION

The present invention relates to an improved photograph and album system.

### BACKGROUND OF THE INVENTION

Prior art photographic albums typically require the consumer to manually insert conventional prints into a classic sleeve, or use adhesive to bond conventional prints to blank album pages. This is a time consuming, difficult operation that provides less than satisfactory results. Consumers often procrastinate and do not place prints in albums when they receive them from the photofinisher, risking loosing time and event references. When adhesives are used to maintain the prints in the album, alignment becomes critical. Additionally, many adhesives can damage a print and often fail after time, thus, allowing the prints to fall out of the album. Also, in addition to purchasing separate binder album pages, adhesive and other items may need to be purchased.

It is well known in the pressure sensitive adhesive industry to provide a pressure sensitive adhesive removability feature by carefully controlling the pressure sensitive adhesive coat weight within a certain range. While controlling the coat weight of the pressure sensitive adhesive does provide removability of the pressure sensitive adhesive for a period of time, the activation time for pressure adhesive with controlled coat weight varies considerably because of coat weight variation in the manufacturing operation. Repositioning pressure sensitive adhesive with controlled coat weight applied to image media would result in unpredictable repositioning time and ultimate bond strength for consumers and therefore would not be suitable for scrapbook and album applications where a predictable repositioning time and ultimate strength are required.

In U.S. Pat. No. 6,045,965, a photographic member with a peelable and repositioning adhesive member is discussed. While the adhesive discussed in U.S. Pat. No. 6,045,965 does reposition to a variety of surfaces, the adhesive formulations disclosed do not form permanent bonds between the photographic member and cellulose paper album pages. Therefore, the photographic member is not optimized for scrapbooks and albums where a permanent bond is valued.

An advantage of the present invention is that creators of photographic albums can easily and quickly mount their photographs in an album without the need for additional mounting means like adhesive. Unobjectionable guide indicia can be used to accurately align photographs on a mounting support. If the results are not satisfactory, the photographs can be repositioned. After sufficient time has passed, the photographs become permanently adhered thereby eliminating the possibility of falling out of the album. Also, the adhesive layer and the receiver layer are specifically designed for use with photographic materials thereby eliminating the possibility of damaging your photographs or album.

### SUMMARY OF THE INVENTION

It is therefore an object of the present invention to provide an improved photograph and album system.

It is another object of the present invention to provide a photographic album having a photograph alignment feature without objectionable alignment indicia.

It is still yet another object of the present invention to provide a photograph and album system that enables a creator to mount photographs in an album that are initially repositionable, and that become permanently mounted with the passage of an event.

### BRIEF DESCRIPTION OF THE DRAWINGS

FIG. 1A shows an image product for use in the present invention;

FIG. 1B is a cross sectional view of the image product of FIG. 1A as taken along line 1-1;

FIG. 1C is a cross sectional view similar to FIG. 1B of a modified image product made in accordance with the present invention;

FIG. 2A shows a mounting support on which the image product of FIG. 1A may be placed;

FIG. 2B is a cross sectional view mounting support of FIG. 2A as taken along line 2-2;

FIG. 2C is a cross sectional view similar to FIG. 2B of a modified mounting support made in accordance with the present invention;

FIG. 3 shows multiple image products of FIG. 1A mounted on a mounting support of FIG. 1B in a first positional configuration of the image products;

FIG. 4 shows multiple image products of FIG. 1A mounted on a mounting support of FIG. 1B in a second positional configuration of the image products;

FIG. 5 shows multiple image products of FIG. 1A mounted on a mounting support of FIG. 1B in a final positional configuration of the image products;

FIG. 6 shows a modified mounting support having an unobjectionable alignment grid;

FIG. 7 shows multiple mounting supports inserted into a photographic album;

FIG. 8 shows a partial cross section of a repositional image product mounted on a mounting support as taken along line 5-5; and

FIG. 9 is the same as FIG. 8 after the passage of time, and showing the image product now permanently mounted on the mounting support.

### DETAILED DESCRIPTION OF THE INVENTION

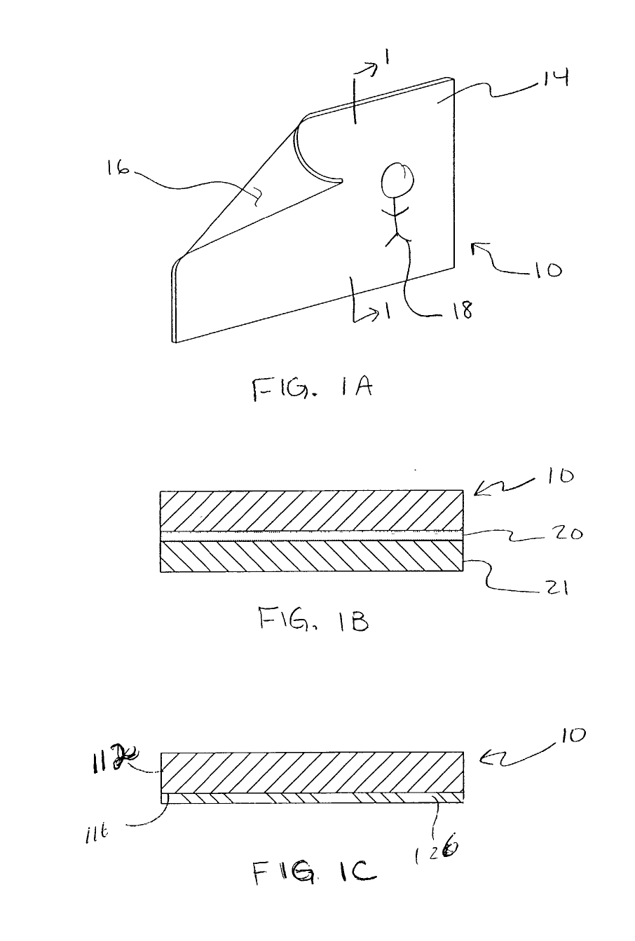

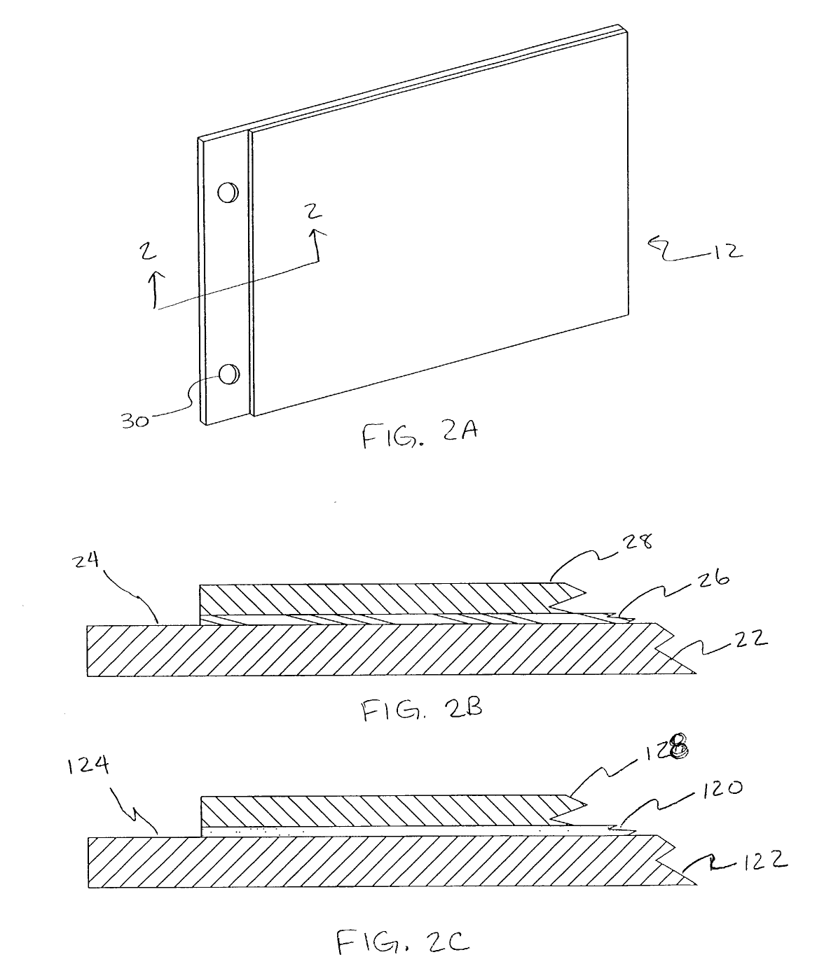

Referring to FIGS. 1A and 1B, there is illustrated an image product 10 that is designed to be positioned on a mounting support 12(see FIG. 2A). In the particular embodiment illustrated, the image product 10 comprises a photographic print suitable for use on an album page having a front surface 14 and a back surface 16. The front surface 14 having an image 18 formed thereon. The back surface 16 is provided with an adhesive layer 20. Release layer 21 is provided to protect adhesive layer 20. In the particular embodiment illustrated, the image product 10 comprises a silver halide photograph. However, the present invention is not so limited and can comprise any other type image on the front. Examples of the other types of images include, but are not limited to inkjet and thermal. It is also to be understood that the adhesive layer 20 may be comprised of any suitable pressure sensitive adhesive.

A pressure sensitive adhesive is an adhesive system that forms a bond with a surface upon contact with the surface under pressure. Pressure sensitive adhesive generally can be placed into three performance categories. The first category is a pressure sensitive adhesive that forms a permanent bond. A permanent pressure sensitive adhesive bond is one that obtains peel strength of greater than 200-grams/5 cm. The second category of pressure sensitive adhesives is removable adhesives. Removable adhesives typically can be removed from a surface for the lifetime of the adhesive and generally have a peel strength of between 10 grams/5 cm and 120 grams/5 cm. The third category of pressure sensitive adhesives is repositional adhesives. Repositional adhesives provide a period of removability, generally 48 hours before the pressure sensitive adhesive bond becomes permanent. Repositional pressure sensitive adhesive systems are preferred for album and scrapbook applications in that they allow images to be repositioned on a page before the bond becomes permanent as most scrapbooks are intended to be durable and long lasting.

In the particular embodiment, adhesive layer 20 is described as being repositional and comprises a tacky, crosslinked solvent dispersed acrylic polymer containing a layer of evenly dispersed non-adhesive solid particles having an average particle diameter of 10 to 60 microns wherein at least about half of the solid particles project from the surface of the adhesive layer to a height corresponding to at least about one-fourth of the average particle diameter of the solid particles. The solid particles comprises 20% by weight of polymer beads and 0.8% by weight of paraffin wax beads. The adhesive layer has a low initial adhesion strength which is enough to position the image product 10 on mounting support 12, but not enough to prevent image product 10 from being relocated.

Release layer 21 comprises a biaxially oriented polyolefin sheet having a matte finish on one side, and a cross-linked silicone coated biaxially oriented polypropylene sheet on the other side. Adhesive layer 20 can be reverse roll coated on the silicone coated side of release layer 21 which then extrusion laminated to back surface 16 of image product 10. The adhesive layer coverage required is approximately 14 g/m2. The photographic print in this example can be processed on traditional photographic processing equipment such as the Gretag 750 Masterlab.

Turning now to FIGS. 2A-2B, mounting support 12 will be described in detail. Mounting support 12 comprises a base layer 22 having a mounting surface 24 on which there is provided a receiver layer 26 thereon. There is an optional protective layer 28 that is provided over the receiver layer 26. In the particular embodiment illustrated, the base layer 22 comprises any suitable paper substrate or the like, and the receiver layer 26 comprises an aqueous solution of gelatin or poly(vinyl alcohol) (PVA). This layer may also contain other hydrophilic materials such as naturally-occurring hydrophilic colloids and gums such as albumin, guar, xanthan, acacia, chitosan, starches and their derivatives, functionalized proteins, functionalized gums and starches, and cellulose ethers and their derivatives, polyvinyloxazoline, such as poly(2-ethyl-2-oxazoline) (PEOX), polyvinylmethyloxazoline, polyoxides, polyethers, poly(ethylene imine), poly(acrylic acid), poly(methacrylic acid), n-vinyl amides including polyacrylamide and polyvinylpyrrolidone(PVP), and poly(vinyl alcohol) derivatives and copolymers, such as copolymers of polyethylene oxide and poly(vinyl alcohol) (PEO-PVA). Two receiver layers may be utilized, one comprising gelatin, and the other comprising poly(vinyl alcohol). The hydrophilic materials employed in the image-recording layer may be present in any amount that is effective for the intended purpose. In general, for a two-layer structure as described above, the preferred amount of gelatin is from about 5 g/m.sup.2 to 15 g/m.sup.2; while the preferred amount of poly(vinyl alcohol) is from about 0.5 g/m.sup.2 to 3.2 g/M.sup.2.

The receiver layer 26 can be coated using a reverse roll coater at a thickness of approximately 10 micrometers. In addition to increasing the surface tension of base layer 22, receiver layer 26 also acts as an ink receiver layer for manual and automatic printing. Protective layer 28 is provided over the receiver layer 26 to protect receiver layer 26 from damage and maintain the integrity of the receiver layer 26. Protective layer 28 comprises a thin sheet of clear plastic, typically polyethylene or polyester.

In this embodiment, receiver layer 26 and protective layer 28 are shown on one side mounting support 12 only. It should be understood that those skilled in the art that receiver layer 26 and protective layer 28 can also be supplied on both sides of mounting support 12 to provide a two-sided mounting support.

Mounting holes 30 can be incorporated in mounting support 12 for the purpose of assembling into an album 62 having a ring binder system. As shown in FIG. 7, it should be understood that multiple mounting supports 12 can be assembled into an album 62. However, the present invention is not so limited and can comprise any other type of binder attachment means well known in the art.

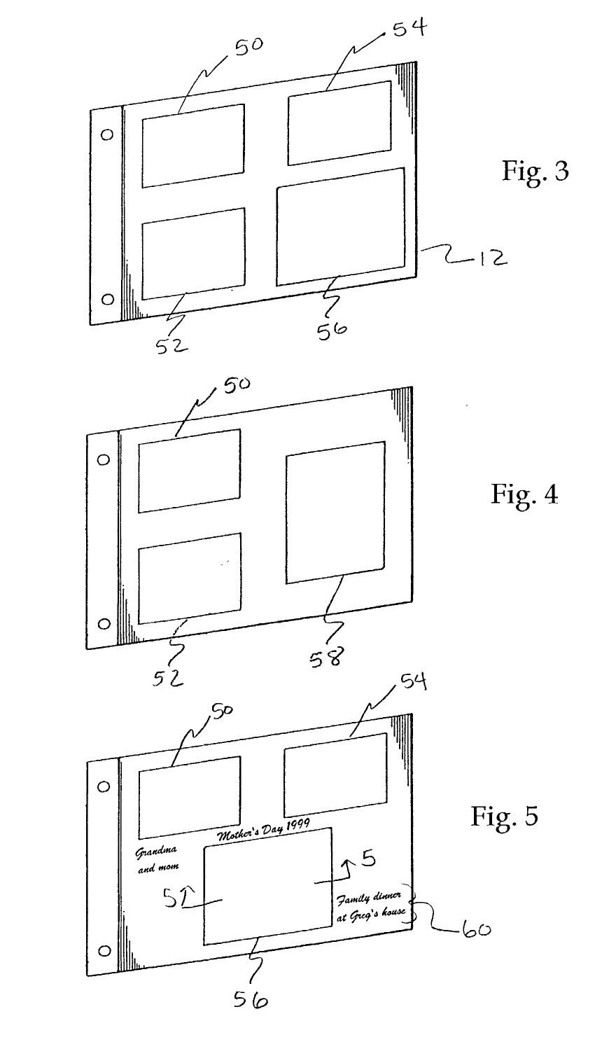

To better understand the present invention, a brief description of its use will now be described with reference to FIGS. 3-5. As shown in FIG. 3, a creator has decided to assemble his/her photographs in a photographic album. Typically the first thing the creator will do is take image product 10, (in this example, image product 10 is represented by photographs 50, 52, 54, and 56) and arrange them on mounting support 12. If protective layer 28 is provided on mounting support 12, it must be taken off at this time. The creator then removes release layer(s) 21 from image product(s) 10 and attaches image product(s) 10 to the mounting surface 24 of mounting support 12.

Adhesive layer 20 on image product 10 is made from a repositional adhesive, therefore as the creator decides that he/she is not completely satisfied with this arrangement, one or all of the photographs can be removed.

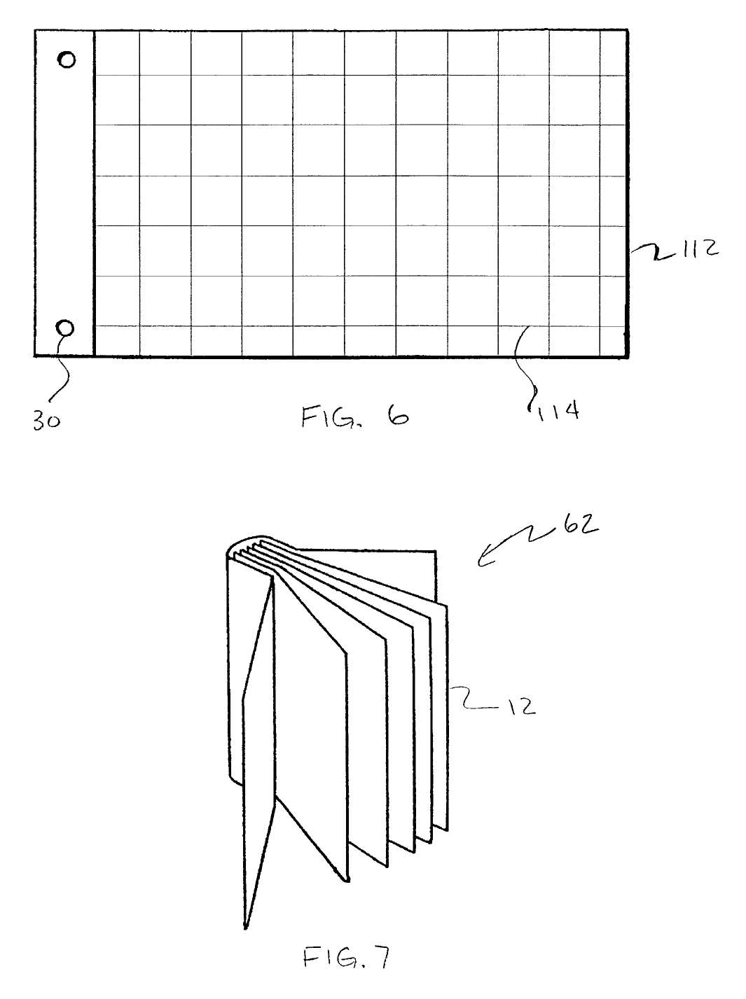

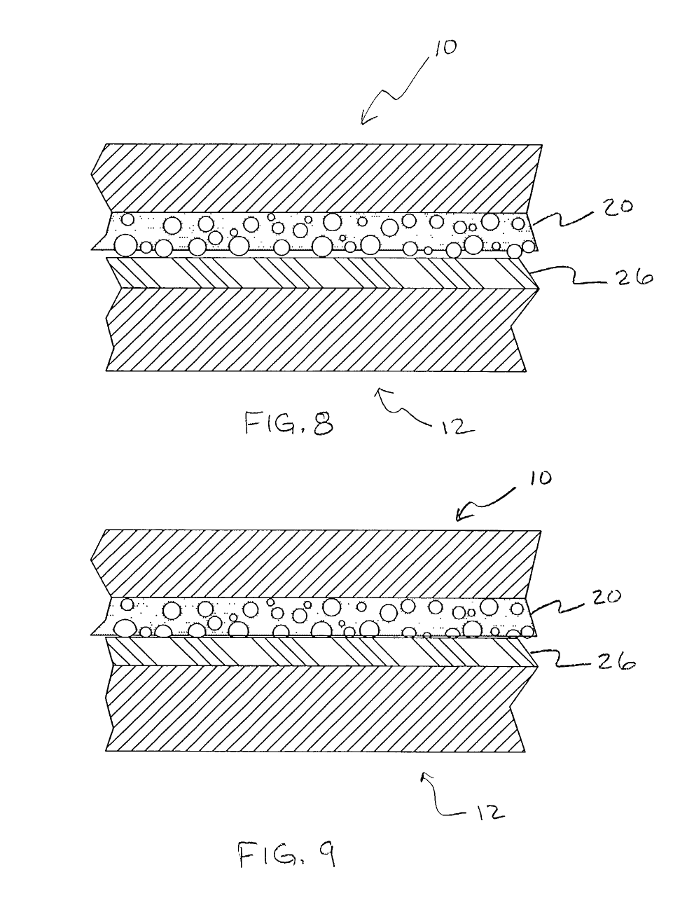

Turning now to FIG. 4, you can see that the creator has removed photographs 54 and 56, and positioned photograph 58 in their place. Still not completely satisfied, the creator has removed photographs 52 and 58, and replaced photographs 54 and 56 as shown in FIG. 5. Finally satisfied, the creator can now add indicia such as text 60 or graphics to the mounting surface 24 of mounting support 12.

Upon the occurrence of a particular event, in this embodiment the application of pressure and the passage of time, the adhesive strength of the adhesive layer 20 develops. Therefore the bond between adhesive layer 20 on image product 10, and the receiver layer 26 on mounting surface 24 of mounting support 12 significantly increases and becomes permanent. Specifically, the adhesive formulation provides a period of removability before the bond cures or migrates or to a permanent bond. The addition of solid particles to an adhesive is known in the art for producing an adhesive formulation that starts as a repositioning adhesive and becomes permanent. The beads provide an initial reduction in contact area, but over time the adhesive layer migrates around the solid particles to increase contact area as the images are stored on an album page due to the compressive forces in a scrapbook. Over time the adhesive migrates from a repositioning adhesive to the desirable permanent bond. The time period for the bond migration typically ranges from 24 hours to 48 hours.

FIG. 8 shows image product 10 mounted on mounting support 12 with adhesive layer 20 adjacent receiver layer 26. The wax and polymer beads contained in adhesive layer 20 are shown limiting the contact area between adhesive layer 20 and receiver layer 26. The image product 10 shown in FIG. 8 has been mounted on mounting support 12 a relatively short period of time, and is considered repositional. Turning now to FIG. 9, image product 10 has been mounted on mounting support 12 a considerably longer period of time as compared to FIG. 8 and is now considered permanent. Adhesive layer 20 has migrated around the wax and polymer beads increasing the contact area between adhesive layer 20 and receiver layer 26.

Bond strength is defined as peel force, and a peel force greater than about 180-grams/5 cm is considered permanent. For instance, photographic prints were evaluated for the force required to separate the image at the adhesive layer and the force required to peel the image from a typical cellulose copier paper with an apparent density of 0.95 grams/cc at 23° C. and 50% RH. The copier paper was used as a reference material to test the repositioning force of the images. The peel forces were measured on an Instron using the 180° peel test at a crosshead speed of 1.0 meters/min and a peel distance of 10 cm (REF. ASTM 3033). The sample width used was 5 cm. The peel strength values for the force required to peel the image layer and imaging support from the copier paper are listed in Table 1 below.

TABLE 1

| Image Peel | | |
|---|---|---|
| (grams/5 cm) | Image Peel (grams/5 cm) | Image Peel (grams/5 cm) |
| After 10 min | After 24 hrs | After 100 hrs |
| 40.2 +/− 10% | 92.3 +/− 10% | 220.2 +/− 10% |

However, the present invention is not so limited and can comprise any other type of adhesive curing method well know in the art. Other curing methods include application of UV energy, visible light, application of heat or microwave, solvent evaporation, or some other criteria such that the bond strength of the adhesive becomes permanent.

At this time, protective layer 28 can be replaced, and release layer 21 from photographs 50, 54, and 56 can be discarded.

As previously described, bond migration is controlled by the migration of the adhesive around the wax and polymer beads. In this first embodiment, the polymer and wax beads are contained in the acrylic polymer of the adhesive. It should be noted that similar bond migration would occur when the polymer and wax beads are contained in the gelatin or poly(vinyl alcohol) (PA) solution of receiver layer 26.

Referring to FIGS. 1C and 2C there is illustrated a modified embodiment made in accordance with the present invention, like numerals indicate like parts and operations as previously discussed. In this embodiment, the receiver layer and adhesive layer are provided on the opposite structures. FIG. 1 C illustrates image product 10 designed to be positioned on mounting support 12. In this particular embodiment, image product 10 is provided with receiver layer 126 on back surface 116.

FIG. 2C illustrates mounting support 122. In this particular embodiment, mounting support 122 is provided with adhesive layer 120 on mounting surface 124. A protective layer 128 is provided over the adhesive layer 120 to protect adhesive layer 120 from damage and maintain the integrity of adhesive layer 120.

In the embodiment of FIGS. 1C and 2C, adhesive layer 120 and protective layer 128 are shown on one side mounting support 112 only. It should be understood that those skilled in the art that adhesive layer 120 and protective layer 128 can also be supplied on both sides of mounting support 112 to provide a two-sided mounting support.

Practicing the invention as described in the modified embodiment of FIGS. 1C and 2C is very similar to the embodiment of FIGS. 1B and 2B. As shown in FIG. 3, the creator has decided to assemble his/her photographs in a photographic album. Typically the first thing the creator will do is take image product 10, (in this example, image product 10 is represented by photographs 50, 52, 54, and 56) and arrange them on mounting support 12. After removing protective layer 28, the creator attaches image product 10 to the mounting surface 24 of mounting support 12. The adhesive layer 20 on mounting support 12 is made from a repositional adhesive, therefore as the creator decides that he/she is not completely satisfied with this arrangement, one or all of the photographs can be removed.

Turning now to FIG. 4, you can see that the creator has removed photographs 54 and 56, and positioned photograph 58 in their place. Still not completely satisfied, the creator has removed photographs 52 and 58, and replaced photographs 54 and 56 as shown in FIG. 5. Optionally, after the image products have been placed in their final position, protective layer 28 can be replaced.

Turning now to FIG. 6, there is illustrated a modified mounting support 112 made in accordance with the present invention, like numerals indicating like parts and operations as previously discussed. In particular, the mounting support 112 is provided with a base layer 22 (not shown) and mounting surface 24 (not shown), and either receiver layer 26 (not shown) or adhesive layer 20 (not shown) as previously discussed. In addition, there is provided a guide indicia 114 comprising a printed grid of horizontal and vertical lines that are visually perceptible at a working distance away from mounting support 12, and substantially visually imperceptible at a viewing distance away from mounting support 112. Guide indicia 114 can be printed using a printing plate exposed through a 10% screen and a specifically formulated printing ink comprising a 50/50 mixture of PMS silver (Pantone877) and opaque white. Guide indicia 114 is useful for alignment of image product 10 on mounting support 112, and particularly useful for mounting multiple image products 10 on the same mounting support where the creator desires the horizontal and/or vertical edge alignment of the image products.

While in the particular invention we have shown that guide indicia 114 obtained by a specific combination of printing plate exposure and printing ink, it should be understood that the providing of a grid that is visually perceptible in a first condition and substantially imperceptible in a second condition may be done in any appropriate manner well known in the are. For instance, guide indicia can be printed in ink that is only visible when irradiated by blacklight, UV, or IR light, or printed in ink that will fade over time with exposure to white light.

The invention has been described in detail with particular reference to certain preferred embodiments thereof, but it will be understood that variations and modifications can be effected within the spirit and scope of the invention.

### Parts List

10 image product

12 mounting support

14 front surface

16 back surface

18 image

20 adhesive layer

21 release layer

22 base layer

24 mounting surface

26 receiver layer

28 protective layer

30 mounting holes

50 photograph

52 photograph

54 photograph

56 photograph

58 photograph

60 text

62 album

112 mounting support

114 guide indicia

120 adhesive layer

122 mounting support

126 receiver layer

128 protective layer

What is claimed is:

1. A kit for repositioning an image product on a mounting support, said kit comprises an image product having a back surface, said back surface having an adhesive layer, and a mounting support, said mounting support having a mounting surface for mating with said back surface so as to secure said image product to said mounting support, said adhesive layer allowing repeated positioning of said image product and also permanent mounting of said image product to said mounting surface.

2. A kit according to claim 1 wherein said permanent mounting occurs after a predetermined period of time has past.

3. A kit according to claim 1 wherein said adhesive layer leaves no appreciable residue on said mounting surface after repeated positioning of said image product and before a permanent mounting is formed.

4. A kit according to claim 1 wherein guide indicia is printed on said mounting surface.

5. A kit according to claim 4 wherein said guide indicia is visually perceptible at a first distance and substantially imperceptible at a second distance, said second distance being greater than said first distance.

6. A mounting support for mounting an image product thereon, said mounting support comprises a mounting surface having a receiver layer thereon for interacting with an adhesive layer provided on a back surface on said image product allowing repeated positioning of said image product and also permanent mounting of said image product to said mounting surface.

7. A mounting support according to claim 6 wherein said permanent mounting occurs after a predetermined period of time has past.

8. A mounting support according to claim 6 wherein said adhesive layer provided on said back surface on said image product leaves no appreciable residue on said mounting surface after repeated positioning of said image product and before a permanent mounting is formed.

9. A mounting support according to claim 6 wherein said receiver layer also accepts marking such as those created by, but not limited to a pen, pencil, marker, and digital printer.

10. A mounting support according to claim 6 wherein guide indicia is printed on said mounting surface.

11. A mounting support according to claim 10 wherein said guide indicia is visually perceptible at a first distance and substantially imperceptible at a second distance, said second distance being greater than said first distance.

12. An image product comprising a back surface, said back surface having an adhesive layer for mating with a mounting surface of a mounting support so as to secure said image product to said mounting surface, said adhesive layer allowing repeated positioning of said image product and also permanent mounting of said image product to said mounting surface.

13. An image product according to claim 12 wherein permanent mounting between said mounting surface and said image product occurs after a predetermined period of time has past.

14. An image product according to claim 12 wherein said adhesive layer is designed to cure so as to provide said permanent mounting upon the application of a catalyst.

15. An image product according to claim 12 wherein said adhesive layer provided on a back surface on said image product leaves no appreciable residue on said mounting surface after repeated positioning of said image product and before a permanent mounting is formed.

16. A kit for repositioning an image product on a mounting support, said kit comprises an image product having a back mounting surface, and a mounting support, said mounting support having a mounting surface and an adhesive layer thereon for mating with said back surface so as to secure said image product to said mounting support, said adhesive layer allowing repeated positioning of said image product and also permanent mounting of said image product to said mounting surface.

17. A kit according to claim 16 wherein said permanent mounting occurs after a predetermined period of time has past.

18. A kit according to claim 16 wherein said adhesive layer leaves no appreciable residue on said image product after repeated positioning of said image product and before a permanent mounting is formed.

19. A kit according to claim 16 wherein guide indicia is printed on said mounting surface.

20. A kit according to claim 19 wherein said guide indicia is visually perceptible at a first distance and substantially imperceptible at a second distance, said second distance being greater than said first distance.

21. A mounting support for mounting an image product thereon, said mounting support comprises an adhesive layer thereon for interacting with a back mounting surface on said image product allowing repeated positioning of said image product and also permanent mounting of said image product to said mounting support.

22. A mounting support according to claim 21 wherein said permanent mounting occurs after a predetermined period of time has past.

23. A mounting support according to claim 21 wherein said adhesive layer leaves no appreciable residue on said image product after repeated positioning of said image product and before a permanent mounting is formed.

24. A mounting support according to claim 21 wherein said adhesive layer is designed to cure so as to provide said permanent mounting upon the application of a catalyst.

25. A mounting support according to claim 21 wherein guide indicia is printed on said mounting surface.

26. A mounting support according to claim 25 wherein said guide indicia is visually perceptible at a first distance and substantially imperceptible at a second distance, said second distance being greater than said first distance.

27. An image product comprising a back mounting surface, said back mounting surface mates with an adhesive layer of a mounting support so as to secure said image product to said mounting surface, said adhesive layer allowing repeated positioning of said image product and also permanent mounting of said image product to said mounting surface.

28. An image product according to claim 27 wherein permanent mounting between said mounting surface and said image product occurs after a predetermined period of time has past.

29. An image product according to claim 27 wherein said adhesive layer provided on a mounting surface on said mounting support leaves no appreciable residue on said image product after repeated positioning of said image product and before a permanent mounting is formed.
